(19) United States
(12) Patent Application Publication
(10) Pub. No.: US 2013/0328893 A1
(43) Pub. Date: Dec. 12, 2013

(54) DISPLAY DEVICE, DISPLAYING METHOD AND COMPUTER-READABLE STORAGE MEDIUM

(71) Applicant: Shin KUSAKARI, Kanagawa (JP)

(72) Inventor: Shin KUSAKARI, Kanagawa (JP)

(73) Assignee: RICOH COMPANY, LTD., TOKYO (JP)

(21) Appl. No.: 13/906,366

(22) Filed: May 31, 2013

(30) Foreign Application Priority Data
Jun. 7, 2012 (JP) 2012-130253

(51) Int. Cl. G09G 5/00

(52) U.S. Cl. CPC G09G 5/005
USPC 345/520

(57) ABSTRACT

A display device includes an identification information receive unit that receives, from a communication device which transmits a radio signal to a predetermined range, predetermined identification information of the communication device, an electromagnetic wave range receive unit that receives an electromagnetic wave range of the communication device based on electromagnetic wave range parameters corresponding to the identification information received by the identification information receive unit, and a screen generate unit that generates a screen for displaying the electromagnetic wave range received by the electromagnetic wave range receive unit at a predetermined position of a predetermined map.

### BACKGROUND OF THE INVENTION

1. Field of the Invention

The present invention relates to a display device, a displaying method and a computer-readable storage medium which are adapted to display an electromagnetic wave range of a communication device.

2. Description of the Related Art

Conventionally, there is a position information management system adapted for identifying and managing positions of radio terminals having received position information of a communication device installed in a predetermined position, positions of people who hold radio terminals, or positions of articles. In the position information management system, a position of each radio terminal has to be in a range which is reached by electromagnetic waves transmitted from the communication device. In order to determine an installation place of radio equipment in a radio communication system, a method of displaying a graphic representation of a field strength distribution of respective channels for the radio terminals is known. For example, see Japanese Laid-Open Patent Publication No. 2011-114416.

However, when displaying a position of each radio terminal according to the known method, the position of the communication device is displayed as the position of the radio terminal, although the actual position of the radio terminal is a position within the electromagnetic wave range of the communication device. In the known method, the graphic representation of the field strength distribution of the respective channels is merely displayed. It is impossible to determine in what range the radio terminal exists from the position of the communication device.

### SUMMARY OF THE INVENTION

In one aspect, the present invention provides a display device which displays an electromagnetic wave range of a communication device.

In an embodiment which solves or reduces one or more of the above-mentioned problems, the present invention provides a display device including: an identification information receive unit which receives, from a communication device which transmits a radio signal to a predetermined range, predetermined identification information of the communication device; an electromagnetic wave range receive unit which receives an electromagnetic wave range of the communication device based on electromagnetic wave range parameters corresponding to the identification information received by the identification information receive unit; and a screen generate unit which generates a screen for displaying the electromagnetic wave range received by the electromagnetic wave range receive unit at a predetermined position of a predetermined map.

Other objects, features and advantages of the present invention will become more apparent from the following detailed description when read in conjunction with the accompanying drawings.

### BRIEF DESCRIPTION OF THE DRAWINGS

FIG. 1 is a diagram showing the outline composition of a position information management system of an embodiment of the invention.

FIG. 2 is a diagram showing an example of a network in which the position information management system of the present embodiment is constructed.

FIG. 3 is a block diagram showing the functional composition of a communication device of the present embodiment.

FIG. 4 is a block diagram showing the functional composition of a managing device of the present embodiment.

FIG. 5 is a block diagram showing the hardware composition of the communication device of the present embodiment.

FIG. 6 is a block diagram showing the hardware composition of the managing device of the present embodiment.

FIG. 7 is a flowchart for explaining a displaying process performed by the managing device of the present embodiment.

FIGS. 8A and 8B are diagrams showing examples of tables stored in a storage unit of the managing device of the present embodiment.

FIGS. 9A and 9B are diagrams showing an example of image data stored in the storage unit of the managing device of the present embodiment.

FIG. 10 is a diagram showing an example of a range indication of an electromagnetic wave range of the communication device.

### DETAILED DESCRIPTION OF THE PREFERRED EMBODIMENTS

A description will be given of embodiments of the present invention with reference to the accompanying drawings.

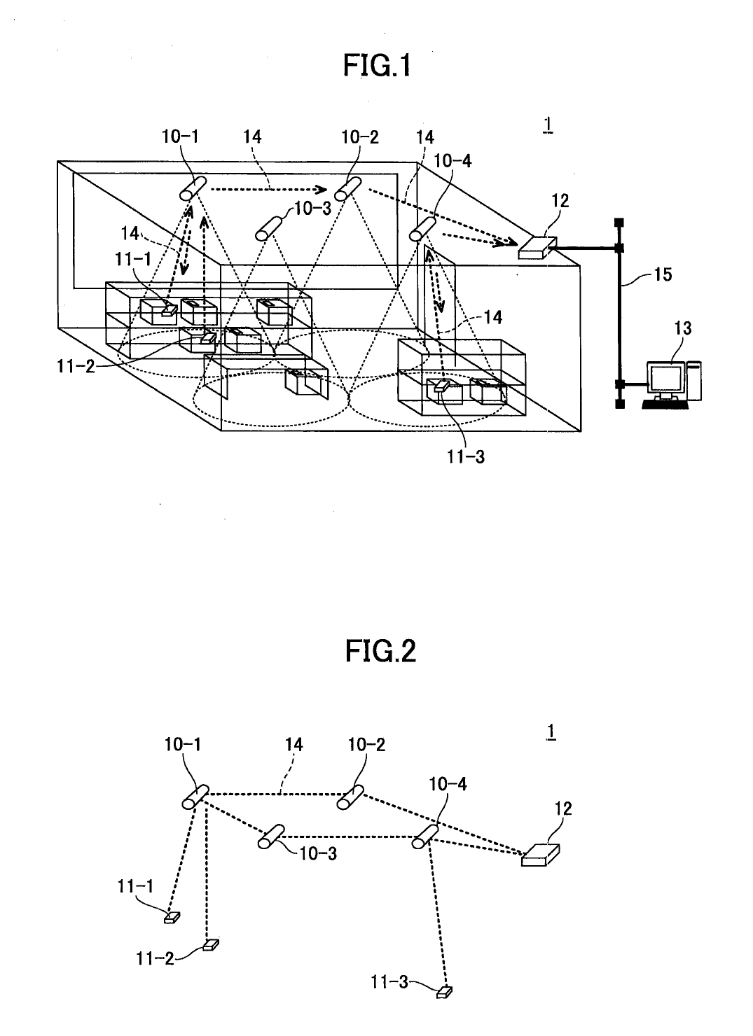

FIG. 1 is a diagram showing of the outline composition of a position information management system 1 of an embodiment of the present invention. As shown in FIG. 1, the position information management system 1 of the present embodiment is arranged to include communication devices 10-1 to 10-4, radio terminals 11-1 to 11-3, a gateway device 12, and a managing device 13. The communication devices 10-1 to 10-4, the radio terminals 11-1 to 11-3, and the gateway device 12 are interconnected by a radio network 14. The gateway device 12 and the managing device 13 are interconnected by a network 15.

For example, the communication devices 10-1 to 10-4 are installed on the ceiling of a room of a building or the like. The communication devices 10-1 to 10-4 are provided to include mutually independent housings. Each communication device may be arranged to operate by electric power supplied from a power supply which is installed beforehand. Alternatively, each communication device may be arranged in a lighting fixture, such as an LED (light emitting diode) fluorescent tube, to operate by electric power supplied from the lighting fixture. In the following, one of the communication devices 10-1 to 10-4 will be referred to as the communication device 10 and one of the radio terminals 11-1 to 11-3 will be referred to as the radio terminal 11.

Each communication device 10 continuously or intermittently transmits to a predetermined range a radio signal (electromagnetic waves for communication) carrying position information of the communication device 10 including an installation position of the communication device 10. For example, the position information of the communication device 10 carried on the radio signal transmitted by the communication device 10 may include longitude/latitude information, a floor number of a building, a building number of the building, etc. Hereinafter, the predetermined range which is reached by the radio signal transmitted from the communication device 10 is equivalent to an electromagnetic wave range of the communication device 10. The electromagnetic wave range (or the predetermined range) of the communication device 10 may be determined by an installation height of the communication device 10 from the ground or the floor, its transmission output, its antenna directivity, etc.

The communication devices 10-1 to 10-4 are arranged so that the management areas of the communication devices as the objects of management do not overlap with each other. However, if the management areas of the communication devices overlap with each other, the radio terminal 11 which receives the radio signals carrying the position information of the communication devices in the position information management system 1 may be arranged to determine one of the communication devices based on the intensity of each of the received electromagnetic waves.

In the example of FIG. 1, the dotted lines drawn from each of the communication devices 10-1 to 10-4, which are in a conical shape, represent the predetermined range (or electromagnetic wave range) of the communication device. For example, the communication device 10 transmits the radio signal carrying the position information of the communication device to the radio terminal 11 via the IMES (indoor messaging system) or the radio network 14.

Each of the communication devices 10-1 to 10-4 is arranged to store a unique identifier (identification information) of the communication device which is set up beforehand. For example, when a request from the managing device 13 is received, the communication device 10 transmits the stored identification information to the managing device 13 via the radio network 14 or the gateway device 12 in response to the request. In the present embodiment, the managing device 13 displays the electromagnetic wave range of the communication device 10 by using the received identification information of the communication device 10, which will be described later.

Each of the radio terminals 11-1 to 11-3 receives a radio signal from the nearest communication device 10 among the communication devices 10-1 to 10-4. In the example of FIG. 1, each radio terminal 11 is attached to the object of management in the shape of a rectangular parallelepiped, the position of which is to be managed by the position information management system. However, the radio terminals in the position information management system according to the present invention are not limited to this example. Alternatively, each radio terminal 11 may be a terminal, such as an active tag which is capable of transmitting autonomously its electromagnetic wave.

When the position information is received from the communication device 10, the radio terminal 11 transmits the received position information and its terminal information to the communication device 10 by the near field wireless communication protocol, such as the IEEE 802.15.4 or the ZigBee®. For example, the terminal information of the radio terminal 11 may be the short address or the IEEE extension (MAC) address according to the IEEE 802.15.4 protocol.

For example, the terminal information and the position information of the radio terminal 11-1 sent to the communication device 10-1 are transmitted to the adjoining communication device 10-2 via the radio network 14, and further transmitted to the gateway device 12 via the adjoining communication device 10-2. The transmitting and receiving operations of the radio terminal 11 may be performed in a predetermined timing or in sync with a time when a change in the acceleration of the radio terminal 11 is detected by an acceleration sensor provided in the radio terminal 11.

For example, the gateway device 12 is installed in each of floors of a building or each of rooms partitioned by walls of a building. The gateway device 12 is arranged to interconnect the radio network 14 and the network 15 and perform the bridging of the information transmitted from the radio network 14 to the network 15. For example, the gateway device 12 is arranged to transform one of the communication modes of the radio network 14 and the network 15 into the other communication mode when the radio network 14 forms a PAN (personal area network) according to the IEEE 802.15.4 standard or the ZigBee® standard and the network 15 forms a LAN (local area network) according to the IEEE 802.3 standard.

In this manner, the gateway device 12 transmits the identification information of the communication device 10 and the terminal information and the position information of the radio terminal 11 which are received from the communication device 10, to the managing device 13 via the network 15. For example, when the terminal information of the radio terminal 11 is expressed by the short address of the IEEE 802.15.4 protocol, the gateway device 12 may be arranged to transform the short address of the radio terminal 11 into the IEEE extension address based on the information of the radio network 14 at the time of forming the PAN, and to transmit the resulting IEEE extension address to the managing device 13.

The managing device 13 receives the identification information of the communication device 10 and the terminal information and the position information of the radio terminal 11 from the communication device 10 via the gateway device 12. The managing device 13 manages the position of the radio terminal 11 based on the received terminal information and the received position information of the radio terminal 11.

When the position of the radio terminal 11 has to be checked, the managing device 13 displays a range indication of the electromagnetic wave range of the communication device 10 on a display part (not shown), so that the range indication of the electromagnetic wave range is included in a floor map displayed on the display part. The radio terminal 11 exists within the electromagnetic wave range of the communication device 10 from which the position information is received. The range indication of the electromagnetic wave range of the communication device 10 is present on the screen of the display part, and the position of the radio terminal 11 can be efficiently checked. The managing device 13 in the present embodiment is equivalent to the display device according to the present invention.

A displaying process performed by the managing device 13 of the present embodiment will be described later. Alternatively, the managing device 13 of the present embodiment may be arranged to incorporate the functions of the gateway device 12.

For example, the radio network 14 is arranged to form the PAN (personal area network) according to the IEEE 802.15.4 standard or the ZigBee® standard. In this case, the radio terminal 11, the communication device 10 and the gateway device 12 are arranged to have the ZigBee end-device functions, the ZigBee router functions and the ZigBee coordinator functions, respectively, which are defined in the ZigBee® standard. For example, upon startup, the communication device 10 and the radio terminal 11 are set up under control of the gateway device 12 to form the PAN, so that the minimum transmission path to the gateway device 12 is determined.

For example, the radio network 14 may be arranged using near field wireless communications, such as Bluetooth LE, ANT, or Z-Wave.

For example, the network 15 forms a LAN (local area network) according to the IEEE 802.3 standard. The network 15 may be arranged to include two or more kinds of networks, such as the Internet.

The radio terminal 11 may be a radio terminal which has functions equivalent to the functions of an active tag, such as a smart phone, a PDA (personal digital assistant), a PC (personal computer), or a smart meter. Alternatively, the object of management of the position information may be a person who holds the radio terminal 11.

FIG. 2 is a diagram showing an example of a network in which the position information management system 1 of the present embodiment is constructed. As shown in FIG. 2, the communication devices 10-1 to 10-4, the radio terminals 11-1 to 11-3 and the gateway device 12 are interconnected by the radio network 14 in the position information management system 1 of FIG. 1. For example, as indicated by the dotted lines in FIG. 2, the information of the radio terminals 11-1 and 11-2 is transmitted from the radio terminals 11-1 and 11-2 to the communication device 10-1, and the same information is transmitted from the communication device 10-1 to the gateway device 12 through the other communication devices 10-2 to 10-4.

The number of the communication devices 10, the arrangement thereof, the number of the radio terminals 11 and the arrangement thereof in the position information management system 1 are not limited to those shown in FIGS. 1 and 2.

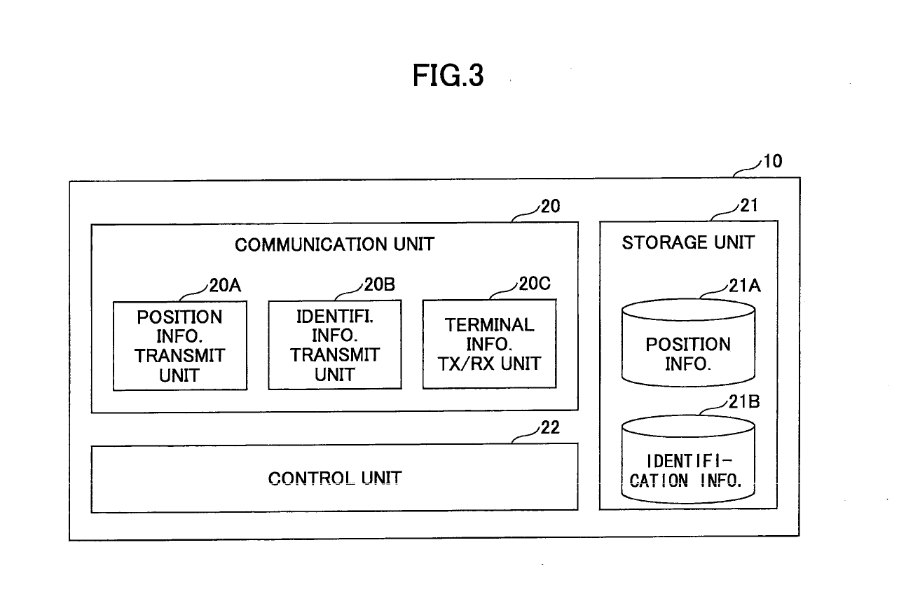

FIG. 3 is a block diagram showing the functional composition of a communication device 10 of the present embodiment. As shown in FIG. 3, the communication device 10 of the present embodiment is arranged to include a communication unit 20, a storage unit 21, and a control unit 22.

The communication unit 20 is arranged to include a position information transmit unit 20A, an identification information transmit unit 20B, and a terminal information transmit/receive unit 20C. The position information transmit unit 20A is configured to continuously or intermittently transmit a radio signal carrying position information 21A to the radio terminals 11-1 to 11-3 which exist within the predetermined range of the communication device. For example, when the radio signal is transmitted through the IMES, the radio signal carrying the position information 21A may be transmitted by using a format specified in the IMES. However, the present invention is not limited to this example.

The identification information transmit unit 20B is configured to transmit identification information 21B to the managing device 13 via the gateway device 12 in response to receiving a request from the managing device 13.

The terminal information transmit/receive unit 20C is configured to receive terminal information and position information from the radio terminal 11. Furthermore, the terminal information transmit/receive unit 20C is configured to transmit the terminal information and the position information to the managing device 13 via the gateway device 12 when the terminal information and the position information are received from the radio terminal 11.

As described above, for example, when the radio network 14 is provided to be in conformity with the ZigBee standard, the communication device 10 may be arranged to transmit the identification information 21B of the communication device 10 and the position information and the terminal information of the radio terminal 11 to the gateway device 12 by using the routing information stored in the communication device 10.

The storage unit 21 is configured to store, for example, the position information 21A and the identification information 21B. However, the present invention is not limited to this example.

The position information 21A may include longitude/latitude information, a floor number of a building, a building number of the building, etc. The floor number in the position information 21A indicates a floor of the building where the communication device 10 is installed. The longitude/latitude information in the position information 21A indicates the latitude and longitude of the position where the communication device 10 exists. The building number in the position information 21A indicates a building number of the building in which the communication device 10 is installed. Alternatively, the position information 21A may further include a more specific information item, such as a partition number indicating a partition in a room of a building.

The identification information 21B may include a unique identifier (identification information) of the communication device 10 which is set up beforehand.

The control unit 22 controls operation of the whole communication device 10. When the communication device 10, the radio terminal 11 and the gateway device 12 form the PAN according to the ZigBee® standard, the communication device 10 is controlled to provide a router function.

As described above, the communication device 10 transmits the identification information to the managing device 13 via the gateway device 12 in response to receiving a request from the managing device 13. After the communication device 10 transmits the position information to the radio terminal 11 and receives the terminal information and the position information from the radio terminal 11, the communication device 10 is enabled to transmit the position information of the communication device 10 and the terminal information and the position information of the radio terminal 11 to the managing device 13 via the gateway device 12.

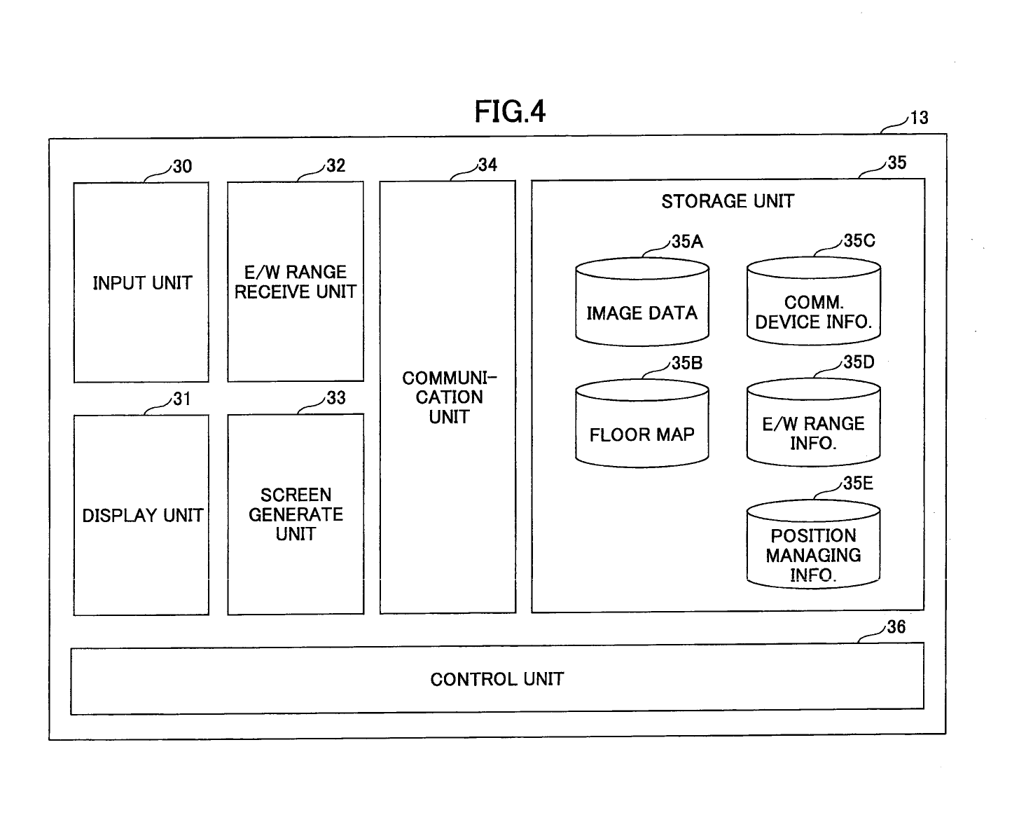

FIG. 4 is a block diagram showing the functional composition of a managing device 13 of the present embodiment. As shown in FIG. 4, the managing device 13 of the present embodiment is arranged to include an input unit 30, a display unit 31, an electromagnetic wave range receive unit 32, a screen generate unit 33, a communication unit 34, a storage unit 35, and a control unit 36.

The input unit 30 is configured to receive the identification information of the communication device 10 via the gateway device 12, receive an input from a user for searching for the position of the radio terminal 11. The input unit 30 is further configured to receive electromagnetic wave range parameters, and the received parameters are used to determine the electromagnetic wave range of the communication device 10.

The display unit 31 is configured to display a screen which is generated by the screen generate unit 33 and composed of GUIs (graphical user interfaces) or the like, on a display part (not shown). The display unit 31 may be configured to display on the display part a list of management departments and device names of the objects of management to which the radio terminals 11-1 to 11-3 are attached. The display unit 31 may be configured to display on the display part a screen including the search results when one of check boxes of the device names is selected by a user using the input unit 30 in order to search for the position of the radio terminal.

The electromagnetic wave range receive unit 32 is configured to receive, when the identification information of the communication device 10 is received at the communication unit 34, the electromagnetic wave range parameters, corresponding to the received identification information, from communication device information 35C stored in the storage unit 35. The electromagnetic wave range receive unit 32 is further configured to receive an electromagnetic wave range based on the received electromagnetic wave range parameters, from electromagnetic wave range information 35D stored in the storage unit 35.

The screen generate unit 33 is configured to generate a screen for displaying the electromagnetic wave range received by the electromagnetic wave range receive unit 32 at a predetermined position of a predetermined map. Specifically, the screen generate unit 33 displays the electromagnetic wave range of the communication device 10 at the predetermined position of the predetermined map, by using image data 35A stored in the storage unit 35. The predetermined map is, for example, a floor map indicating a floor of a building in which the communication device 10 is installed. The predetermined position of the predetermined map is, for example, the installation position of the communication device 10.

The screen generate unit 33 may be configured to convert the scale of the electromagnetic wave range in accordance with the scale of the predetermined map, and generate a screen for displaying the image data 35A corresponding to the scale-changed electromagnetic wave range at the predetermined position of the predetermined map.

The communication unit 34 is configured to transmit data to and receive data from the communication device 10 and the radio terminal 11, which are included in the radio network 14, via the gateway device 12. Specifically, the communication unit 34 sends a request for transmitting the identification information to the communication device 10, and receives the identification information sent by the communication device 10 in response to the request.

The communication unit 34 in the present embodiment is equivalent to an identification information receive unit of the display device according to the present invention.

The communication unit 34 may be configured to transmit the screen for displaying the electromagnetic wave range, generated by the screen generate unit 33, to an external device, such as a mobile terminal. The communication unit 34 may be configured to transmit the position information of the radio terminal 11 to an external device, such as a mobile terminal. When the communication device 10 stores its transmission output information, the communication unit 34 may be configured to receive the transmission output information from the communication device 10. The communication unit 34 may be configured to store, when the terminal information and the position information sent from the radio terminal 11 are received via the communication device 10, the terminal information and the position information of the radio terminal 11 into the storage unit 35 together with a reception date/time of such information.

The storage unit 35 is configured to store the image data 35A, a floor map 35B, the communication device information 35C, the electromagnetic wave range information 35D, and position managing information 35E. However, the present invention is not limited to this embodiment.

The image data 35A may include image data, such as an open circle, for displaying a range indication of the electromagnetic wave range of the communication device 10. For example, the image data may include digital image information of a bitmap image. An example of the image data 35A will be described layer.

The floor map 35B may include map information of a floor map indicating a floor of a building in which the communication device 10 is installed, and the scale information of the floor map when the floor map is displayed in a screen. The map information is not limited to an interior floor map. The map information may indicate an exterior portion of a building. An example of the floor map 35B will be described later.

The communication device information 35C may include a table for storing the relevant information items regarding the communication device 10. For example, the communication device information 35C includes items of a communication device ID, an installation position, an installation height, a transmission output, etc. The communication device ID item indicates a unique identifier (identification information) of the communication device 10 which is set up beforehand. The installation position item indicates a position of a floor or a building in which the communication device 10 is installed. The installation height item indicates a height (ceiling height) of the communication device 10 from the ground or the floor. The transmission output item indicates a transmission output of the electromagnetic waves for communication of the communication device 10. The installation height and the transmission output obtained from the communication device information 35C in the present embodiment are equivalent to the electromagnetic wave range parameters according to the present invention. An example of the communication device information 35C will be described later.

The electromagnetic wave range information 35D may include a table for storing information items indicating the radius of the electromagnetic wave range of the communication device 10 corresponding to the transmission output and the installation height of the communication device 10. For example, the radius of the electromagnetic wave range is the value actually verified by experiment. An example of the electromagnetic wave range information 35D will be described later.

The position managing information 35E may include a table for managing the position information of the radio terminal 11. For example, the position managing information 35E may include items of the terminal information of the radio terminal 11, the device name of a device to which the radio terminal 11 is attached, the management department of the radio terminal 11 or the device to which the radio terminal 11 is attached, the position information (latitude, longitude, floor, building) of the radio terminal 11, and the reception date/time of the position information.

The control unit 36 controls the above-described elements of the managing device 13. By using the above-described composition, the managing device 13 displays the electromagnetic wave range of the communication device 10, so that the position of the radio terminal 11 can be easily determined.

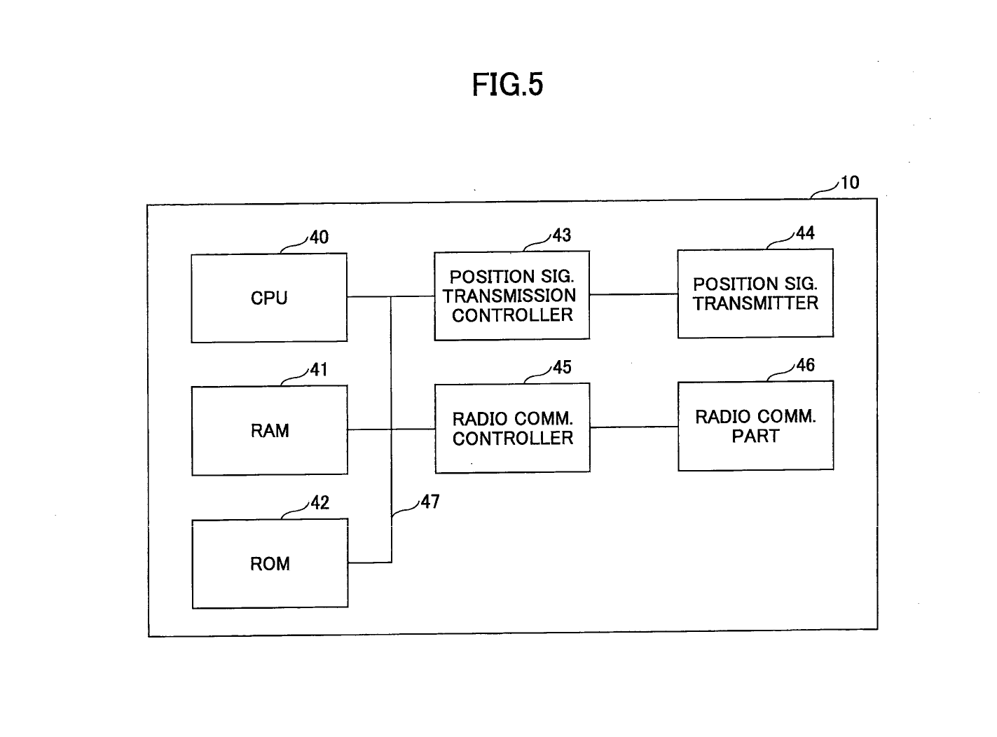

FIG. 5 is a block diagram showing the hardware composition of the communication device 10 of the present embodiment. As shown in FIG. 5, the communication device 10 of the present embodiment is arranged to include a CPU (central processing unit) 40, a RAM (random access memory) 41, a ROM (read only memory) 42, a position signal transmission controller 43, a position signal transmitter 44, a radio communication controller 45, and a radio communication part 46. These elements of the communication device 10 are interconnected by a bus 47.

The CPU 40 executes a program which carries out operation control of the communication device 10. The RAM 41 provides the work area of the CPU 40 when the program is executed by the CPU 40. The ROM 42 stores the program executed by the CPU 40, and the identification information and the position information of the communication device 10.

The position signal transmission controller 43 controls execution of a transmission process for transmitting a position signal which indicates the position information of the communication device 10 through the position signal transmitter 44. For example, the position signal transmitter 44 is arranged to include an antenna for transmitting the position signal according to the IMES.

The radio communication controller 45 controls execution of a radio communication process using the radio communication part 46. For example, the radio communication part 46 is arranged to include an antenna for transmitting and receiving the electromagnetic waves in conformity with the IEEE 802.15.4 standard. The bus 47 electrically connects these elements of the communication device 10 with each other.

By using the above-described composition, the communication device 10 transmits the identification information of the communication device 10 to the managing device 13 via the gateway device 12 in response to receiving a request from the managing device 13. After the communication device 10 transmits the position information of the communication device 10 to the radio terminal 11 and receives the terminal information and the position information of the radio terminal 11 from the radio terminal 11, the communication device 10 is enabled to transmit the received terminal information and position information to the managing device 13 via the gateway device 12.

If the position information of the communication device 10 is transmitted by using the radio communication controller 45 and the radio communication part 46, the use of the position signal transmission controller 43 and the position signal transmitter 44 becomes unnecessary.

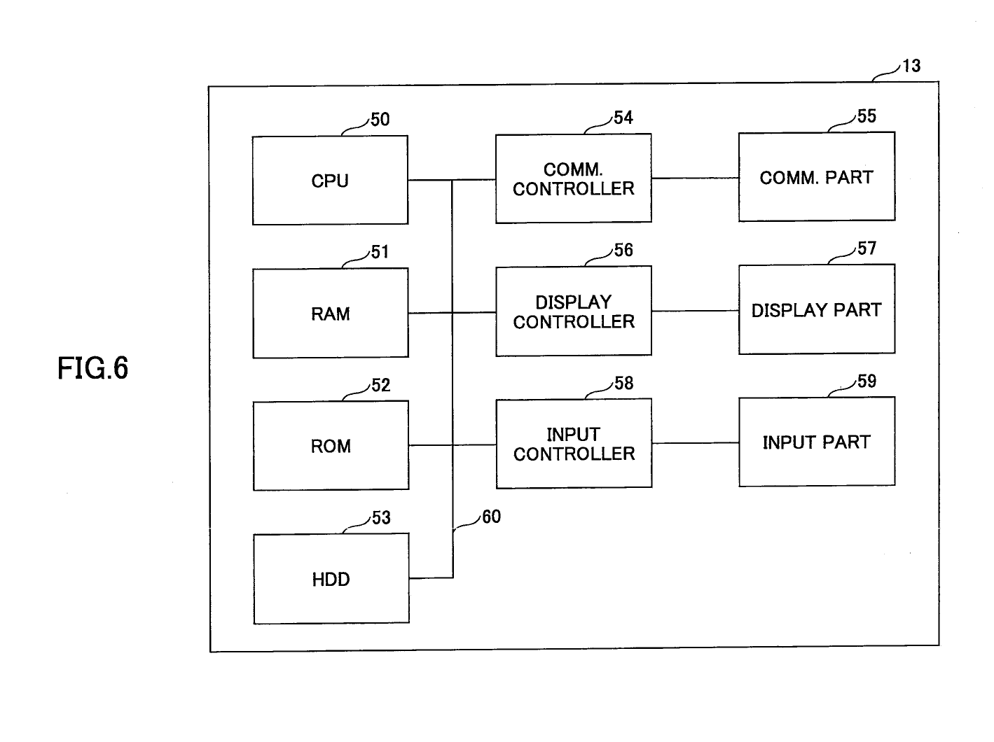

FIG. 6 is a block diagram showing the hardware composition of the managing device 13 of the present embodiment. As shown in FIG. 6, the managing device 13 of the present embodiment is arranged to include a CPU 50, a RAM 51, a ROM 52, a HDD (hard disk drive) 53, a communication controller 54, a communication part 55, a display controller 56, a display part 57, an input controller 58, and an input part 59. These elements of the managing device 13 are interconnected by a bus 60.

The CPU 50 executes a program which carries out operation control of the managing device 13. The RAM 51 provides the work area of the CPU 50 when the program is executed by the CPU 50. The ROM 52 stores the program executed by the CPU 50 and data used by the program.

The HDD 53 stores the information for displaying the electromagnetic wave range of the communication device 10 used in the position information management system 1, and the information for managing the position of the radio terminal 11. The HDD 53 may be any other storage device, such as a tape drive, or may be a storage area which can be accessed via a network.

The communication controller 54 controls execution of a communication process using the communication part 55. For example, the communication part 55 is arranged to include a network interface in conformity with the IEEE 802.3 standard.

The display controller 56 controls the content of the information displayed on the display part 57 according to the content of the process performed by the managing device 13. For example, the display part 57 is arranged to include a liquid crystal display or a CRT (cathode ray tube) display.

The input controller 58 controls execution of the signal processing of an input signal from the input part 59. For example, the input part 59 is arranged to include a keyboard and a pointing device, such as a mouse, for receiving an input from a user. The bus 60 electrically connects these elements of the managing device 13 with each other.

By using the above-described composition, the managing device 13 displays the electromagnetic wave range of the communication device 10, so that the position of the radio terminal 11 can be easily searched for. Alternatively, the managing device 13 may be arranged to include the controller and other parts of the gateway device 12 for performing wireless communication, so that the managing device 13 may perform the process of the gateway device 12.

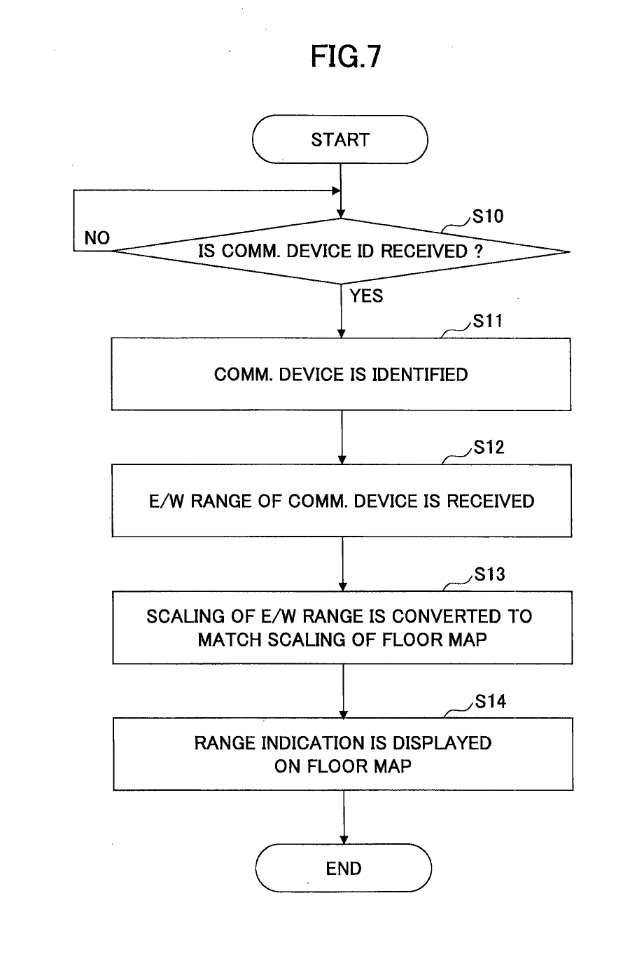

FIG. 7 is a flowchart for explaining a displaying process performed by the managing device 13 of the present embodiment.

As shown in FIG. 7, upon start of the displaying process, the managing device 13 determines whether the identification information (ID) of the communication device 10 is received via the communication unit 34 (S10). When it is determined at step S10 that the identification information of communication device 10 is not received, the managing device 13 continuously performs step S10.

When it is determined at step S10 that the identification information of the communication device 10 is received, the managing device 13 causes the electromagnetic wave range receive unit 32 to access the communication device information 35C, and identifies the communication device 10 corresponding to the received identification information (S11). Subsequently, the managing device 13 causes the electromagnetic wave range receive unit 32 to receive the installation height and the transmission output of the communication device 10 identified at step S11 from the communication device information 35C, and then receive the electromagnetic wave range (radius) of the communication device 10 from the electromagnetic wave range information 32D (S12).

Subsequently, the managing device 13 causes the screen generate unit 33 to receive a floor map, indicating a floor of a building in which the communication device 10 is installed, and the scale information of the floor map from the floor map 35B. The managing device 13 causes the screen generate unit 33 to change the scale of the electromagnetic wave range received at step S12 based on the received scale information so that the changed scale of the electromagnetic wave range is the same as the scale of the floor map (S13).

Subsequently, the managing device 13 causes the screen generate unit 33 to display the range indication of the image data 35A corresponding to the scale-changed electromagnetic wave range at the installation position of the communication device 10 on the floor map (S14). Then, the displaying process is terminated.

By performing the above-described displaying process, the managing device 13 can display the electromagnetic wave range of the communication device 10 on the floor map indicating the floor of the building in which the communication device 10 is installed.

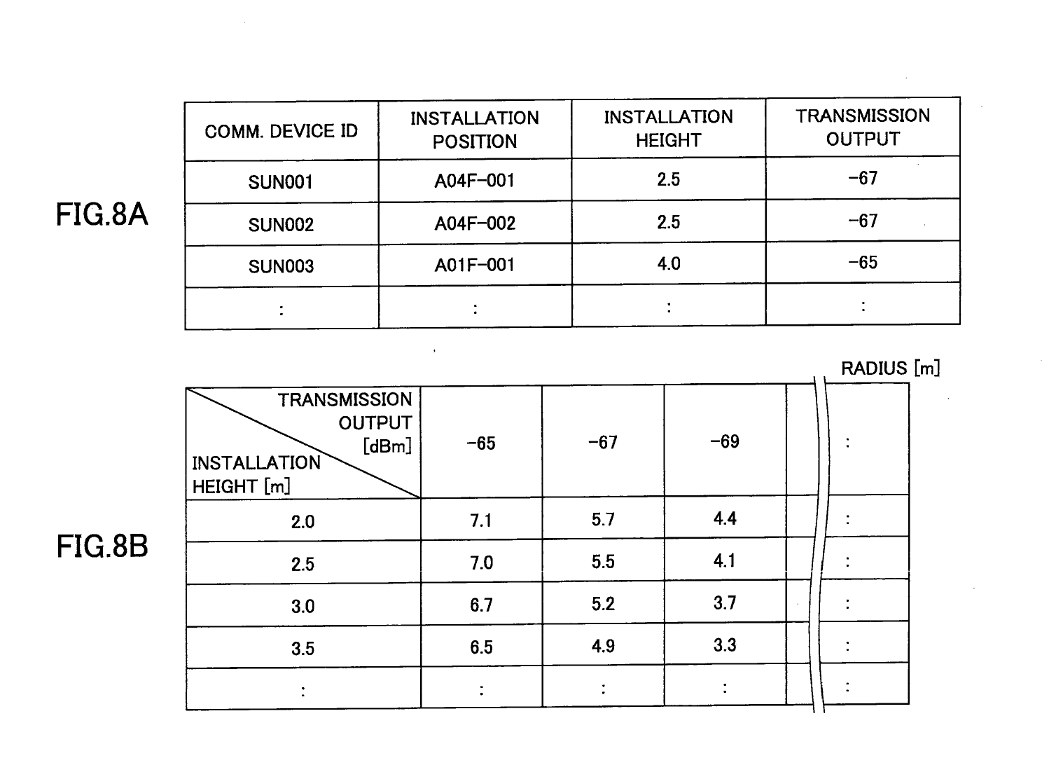

FIGS. 8A and 8B are diagrams showing examples of tables stored in the storage unit 35 of the managing device 13 of the present embodiment. Specifically, FIG. 8A shows an example of the table of the communication device information 35C and FIG. 8B shows an example of the table of the electromagnetic wave range information 35D.

As shown in FIG. 8A, the table of the communication device information 35C includes items of “communication device ID”, “installation position”, “installation height”, “transmission output”, etc. For example, the communication device ID item denotes a unique identifier (identification information) of the communication device 10, such as “SUN001”, which is set up beforehand. The installation position item denotes an installation position of the communication device 10. For example, in the case of “A04F-001”, the installation position item means that the communication device 10 is installed at the position of “building A, 4th floor, 001”. The installation height item denotes a ceiling height of the communication device 10 from the ground or the floor. The transmission output item denotes a transmission output of the electromagnetic waves for communication of the communication device 10.

As shown in FIG. 8B, the table of the electromagnetic wave range information 35D stores information on the electromagnetic wave range (radius [m]) of the communication device 10 which is calculated based on the relationship between the installation height [m] and the transmission output [dBm] of the communication device 10. When the antennas of the communication devices 10-1 to 10-4 have directivity, the value of the electromagnetic wave range which is calculated based on the relationship in which the directivity of each antenna is further taken into consideration may be used.

The present invention is not limited to the items of the communication device information 35C and the items of the electromagnetic wave range information 35D which are specifically disclosed in the present embodiment.

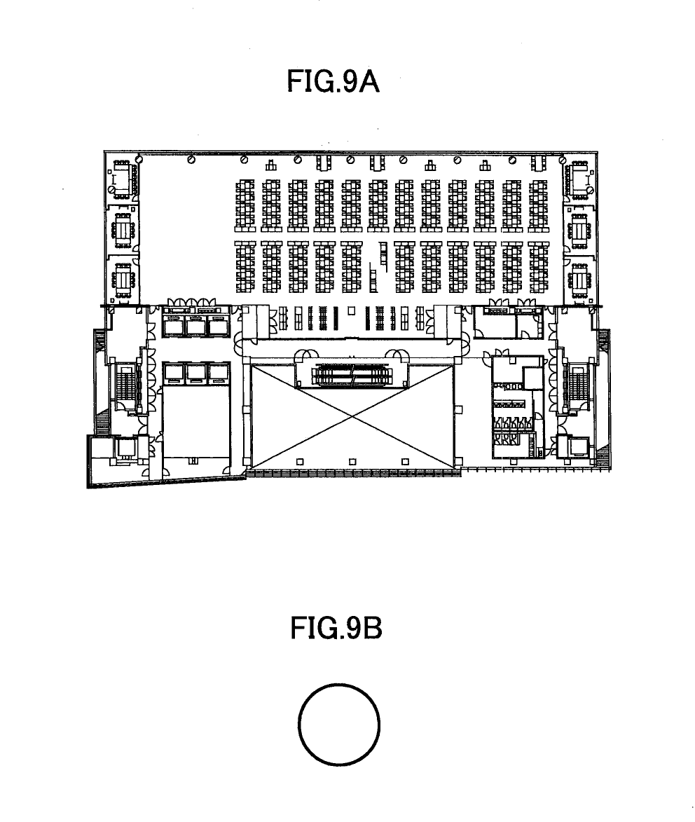

FIG. 9A and FIG. 9B are diagrams showing examples of image data stored in the storage unit 35 of the managing device 13 of the present embodiment. Specifically, FIG. 9A shows an example of a floor map which indicates a floor of a building in which the communication device 10 is installed and FIG. 9B shows an example of image data (an open circle) which indicates the electromagnetic wave range of the communication device 10.

Next, an example of the displaying process of FIG. 7 will be described with reference to FIGS. 8A-8B and 9A-9B. When the communication device ID (identification information) of the communication device 10 which is received at step S11 in the displaying process of FIG. 7 by the managing device 13 is “SUN001”, the managing device 13 determines, based on the communication device information 35C, that the installation position of the communication device 10 is “A04F-001”, the installation height of the communication device 10 is “2.5 [m]” and the transmission output of the communication device 10 is “−67 [dBm]”.

Subsequently, at step S12, the managing device 13 accesses the electromagnetic wave range information 32D and determines that the electromagnetic wave range corresponding to the installation height “2.5 [m]” and the transmission output “−67 [dBm]” of the communication device 10 is the radius “5.5 [m]”.

Subsequently, at step S13, the managing device 13 receives from the floor map 35B a floor map indicating a floor of a building in which the communication device 10 is installed (for example, the floor map shown in FIG. 9A) and the scale information (for example, 1/150) of the floor map.

For example, the radius of the electromagnetic wave range “5.5 [m]” x the scale 1/150≈3.7 [m], and the managing device 13 determines that the scale-changed radius of the electromagnetic wave range corresponding to the received scale information of the floor map is 3.7 [m].

Subsequently, at step S14, the managing device 13 changes the radius of the circle of the image data of FIG. 9B to 3.7 [m] and superimposes the scale-changed range indication over the floor map of FIG. 9A by matching the center of the circle of the image data with the installation position (for example, “001”) of the communication device 10 on the floor map. This enables the managing device 13 to display the electromagnetic wave range of the communication device 10 on the floor map of FIG. 9A.

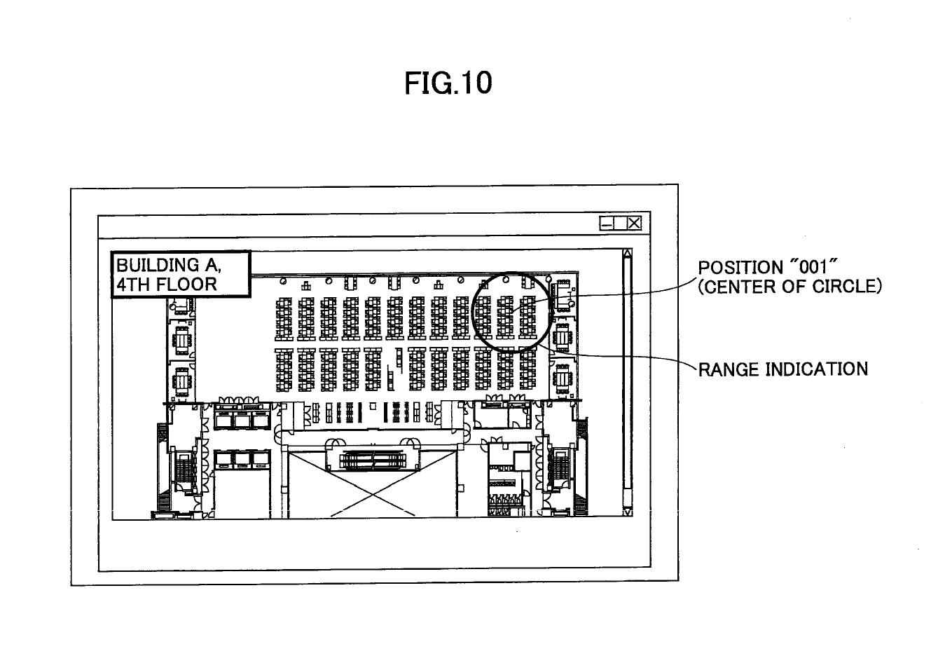

FIG. 10 is a diagram showing an example of the range indication of the electromagnetic wave range of the communication device. As shown in FIG. 10, the image data which indicates the electromagnetic wave range of the communication device 10 is superimposed over the floor map of the building A, 4th floor displayed on the screen of the display part, and the installation position (for example, the position “001”) of the communication device 10 is indicated as the center of the circle of the image data.

As described above, the range of the circle of the image data which indicates the electromagnetic wave range of the communication device 10 is converted in accordance with the scale of the floor map displayed on the screen of the display part, and it is possible to appropriately display the electromagnetic wave range of the communication device 10 on the floor map.

As described above, the identification information and the position information of the communication device 10 which are associated with each other are stored in the storage unit 35 of the managing device 13. When the position information of the communication device 10 is received and the position of the radio terminal 11 has to be checked, the managing device 13 can display the electromagnetic wave range of the communication device 10 on the floor map so that the user can easily determine the range in which the radio terminal 11 may exist.

As described in the foregoing, according to the embodiments of the present invention, it is possible to display the electromagnetic wave range of the communication device.

The present invention can be implemented in any convenient form, for example, using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can comprise any suitably programmed apparatuses such as a general purpose computer, personal digital assistant, mobile telephone (such as a WAP or 3G-compliant phone) and so on. Because the present invention can be implemented as software, each and every aspect of the present invention thus encompasses computer software implementable on a programmable device.

The computer software can be provided to the programmable device using any storage medium for storing processor readable code such as a floppy disk, a hard disk, a CD ROM, a magnetic tape device or a solid state memory device.

The hardware platform includes any desired hardware resources including, for example, a central processing unit (CPU), a random access memory (RAM), and a hard disk drive (HDD). The CPU may include processors of any desired type and number. The RAM may include any desired volatile or nonvolatile memory. The HDD may include any desired nonvolatile memory capable of recording a large amount of data.

The hardware resources may further include an input device, an output device, and a network device in accordance with the type of the apparatus. The HDD may be provided external to the apparatus as long as the HDD is accessible from the apparatus. In this case, the CPU, for example, the cache memory of the CPU, and the RAM may operate as a physical memory or a primary memory of the apparatus, while the HDD may operate as a secondary memory of the apparatus.

The display device of the present invention is not limited to the specifically disclosed embodiments, and variations and modifications may be made without departing from the scope of the present invention.

The present application is based on and claims the benefit of priority of Japanese Patent Application No. 2012-130253, filed on Jun. 7, 2012, the contents of which are incorporated herein by reference in their entirety.

What is claimed is:

1. A display device, comprising:
an identification information receive unit configured to receive, from a communication device which transmits a radio signal to a predetermined range, predetermined identification information of the communication device;
an electromagnetic wave range receive unit configured to receive an electromagnetic wave range of the communication device based on electromagnetic wave range parameters corresponding to the identification information received by the identification information receive unit; and
a screen generate unit configured to generate a screen for displaying the electromagnetic wave range received by the electromagnetic wave range receive unit at a predetermined position of a predetermined map.

2. The display device according to claim 1, further comprising a storage unit configured to store image data of the electromagnetic wave range,
wherein the screen generate unit is configured to generate the screen for displaying the electromagnetic wave range at the predetermined position of the predetermined map by using the image data from the storage unit.

3. The display device according to claim 1, wherein the electromagnetic wave range receive unit is configured to receive the electromagnetic wave range based on a relationship between an installation height of the communication device from a ground or a floor and a transmission output of the communication device which are included in the electromagnetic wave range parameters.

4. The display device according to claim 1, wherein the screen generate unit is configured to change a scale of the electromagnetic wave range based on a scale of the predetermined map and generate the screen for displaying image data corresponding to the scale-changed electromagnetic wave range at the predetermined position of the predetermined map.

5. The display device according to claim 1, wherein the radio signal transmitted by the communication device carries position information of the communication device.

6. A displaying method performed by a display device, comprising:
receiving by an identification information receive unit of the display device, from a communication device which transmits a radio signal to a predetermined range, predetermined identification information of the communication device;
receiving by an electromagnetic wave range receive unit of the display device an electromagnetic wave range of the communication device based on electromagnetic wave range parameters corresponding to the received identification information; and
generating by a screen generate unit of the display device a screen for displaying the received electromagnetic wave range at a predetermined position of a predetermined map.

7. A non-transitory computer-readable storage medium storing a program representing a sequence of instructions, the program which when executed by a computer included in a display device, causes the computer to perform a displaying method comprising:
receiving by an identification information receive unit of the display device, from a communication device which transmits a radio signal to a predetermined range, predetermined identification information of the communication device;
receiving by an electromagnetic wave range receive unit of the display device an electromagnetic wave range of the communication device based on electromagnetic wave range parameters corresponding to the received identification information; and
generating by a screen generate unit of the display device a screen for displaying the received electromagnetic wave range at a predetermined position of a predetermined map.
